(19) United States
(12) Patent Application Publication
(10) Pub. No.: US 2004/0179376 A1
(43) Pub. Date: Sep. 16, 2004

(54) Luminescent apparatus

(75) Inventors: Kwok Lit Chan, Hong Kong (CN); Tai Wing David Yeung, Wanchai (CN)

Correspondence Address: BURNS, DOANE, SWECKER & MATHIS, L.L.P., P.O. Box 1404, Alexandria, VA, 22313-1404, US

(73) Assignee: Everjet Industrial Limited

(21) Appl. No.: 10/383,732

(22) Filed: Mar. 10, 2003

(51) Int. Cl. F21V 5/02

(52) U.S. Cl. 362/806; 362/339

(57) ABSTRACT

A lighting device (10, 11) including:

(a) a light source,

(b) a distal light scattering means,

(c) a transparent or translucent surface,

(d) the distal light scattering means being disposal at a distance away from the light source and outside said housing (60),

(e) the distal light scattering means becomes generally luminous when illuminated by the light source, and

(f) the light source being surrounded by a housing (60) including at least a transparent or translucent surface.

### FIELD OF THE INVENTION

This invention relates to luminescent devices, means and apparatus and, more particularly, to electroluminescent devices, means and apparatus. More specifically, although of course not solely limited thereto, this invention relates to decorative electroluminescent devices.

### BACKGROUND OF THE INVENTION

Lighting devices, especially electroluminescent devices or apparatus are widely used for generally lighting purpose as well as a means of decoration. A typical lighting device includes a light-emitting source, such as a light bulb or a fluorescent tube, to produce the necessary luminosity. The light can then be directed towards a scattering body, for example, a crystal ball, to produce more or secondary decorative lighting effects.

However, conventional ways for producing decorating lighting effects are somewhat limited. It will be desirable if there can be provided means, device or apparatus for producing or improving decorative lighting effects. It will be highly desirable if such lighting effects are remarkable or interesting while do not require very complicated arrangements. Furthermore, with the rapid improvements in light-emitting diodes (LEDs) recently, LEDs have become a viable choice for use in lighting devices and apparatus, whether for decorative purpose or for basic general lighting needs. Hence, it will be desirable if there can be provided improved lighting devices, especially decorative lighting apparatus, with LED light sources.

### OBJECT OF THE INVENTION

Accordingly, it is an object of the present invention to provide improved lighting means, devices and apparatus. Specifically, it is an object of this invention to provide improved electroluminescent decorative lighting means, devices and apparatus. In addition, the lighting effects will be interesting or remarkable and can be effected without expensive or complicated arrangements. More specifically, it is an object of the present invention to provide electroluminescent lighting devices, means and apparatus including light-emitting diodes as a light source. At a minimum, it is an object of this invention to provide the public with a useful choice of electroluminescent lighting devices, means and apparatus.

### SUMMARY OF THE INVENTION

According to the present invention, there is provided . . .

According to another aspect of this invention, there is provided . . .

### BRIEF DESCRIPTION OF THE DRAWINGS

Preferred embodiments of the present invention will be explained in further detail below by way of examples and with reference to the accompanying drawings in which:—

FIG. 1 is a perspective view of a decorative electroluminescent lighting device of a first preferred embodiment of the present invention,

FIG. 2 is an exploded view of the lighting device of FIG. 1,

FIG. 3 is a longitudinal cross-sectional view of the lighting device of FIG. 1,

FIG. 3A shows an enlarged cross-sectional view of the light-emitting diode lighting source of FIG. 3,

FIG. 4 is a longitudinal cross-sectional view of a second preferred embodiment of a lighting device of the present invention, and

FIG. 5 is an exploded view of the lighting device of FIG. 4.

### DETAILED DESCRIPTION OF THE PREFERRED EMBODIMENTS

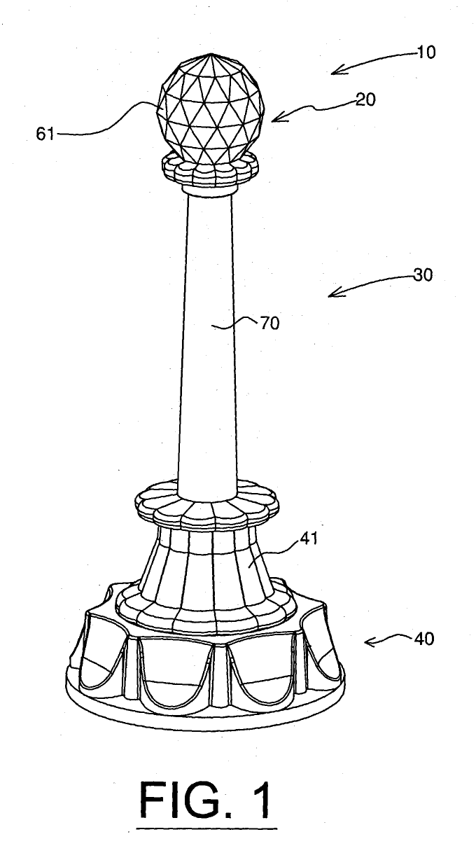

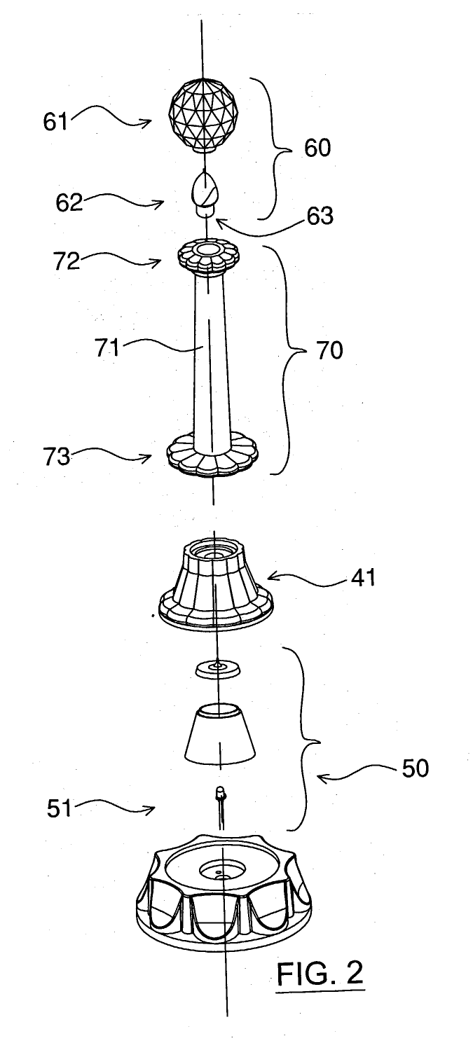

Referring to FIGS. 1 to 3, there is shown a first preferred embodiment of the present invention in the form of an electroluminescent lighting device 10. The lighting device 10 includes a head portion 20, a neck portion 30 and a base portion 40. The lighting device 10 also includes a light source 50, a distal light scattering means 60 and an optical guide 70 interconnecting the light source 50 and the distal light scattering means 60. The light source 50 is generally surrounded by part of the base housing 41 which includes at least a transparent or translucent window or surface. The distal light scattering means 60 includes a light scattering body 61 which, when placed along the path of a light beam, will scatter or deflect the light beam into a plurality of beams along a plurality of orientations or directions. In this example, the light scattering body 61 includes a generally spherical body made of a clear and transparent material such as, plastics, glass or crystal. In addition, the light scattering body 61 has a relatively high refractive index. The outer surface of the light scattering body 61 is extensively faceted to enhance the optical scattering, diffraction or deflection characteristics. In order to provide a more versatile or sophisticated distal light scattering means, the inside of the light scattering body 61 is generally hollow with an intermediate light scattering member 62 disposed inside. This intermediate light scattering body 62 includes a coloured body, which is generally transparent or translucent, to provide additional visual complexity to the distal light scattering means. In addition, the intermediate light scattering body may include a multi-coloured body formed by mosaicing a plurality of coloured bodies to form a multi-coloured scattering means. To minimize the adverse attenuation of light due to the intermediate light scattering body, this light body is also thin and hollow with a light receiving aperture 63 aligned towards the light source 50. Furthermore, the upper portion of the intermediate light scattering body 62 in this example resembles a bulb or a burning flame so that the lighting device will have a general appearance of a burning candle and the bulb-shaped body is formed by two coloured parts which, together, resemble a burning flame. In general, the light scattering phenomena effected by the distal light scattering means will be a combined effect of the first light scattering body 61 and the intermediate light scattering body 62.

The optical guide 70 generally provides an optical path for the light emitted by the light source 50 to travel towards the distal light scattering means 60. In this specific embodiment, the optical guide 70 includes an elongated hollow tubular member generally extending between the light source and the distal light scattering means. The cylindrical wall of the hollow tubular member 71 generally surrounds the light which travels from the light source towards the distal light scattering means. In this specific example, the hollow tubular member is substantially transparent and the transit of light between the light source 50 disposed at the base portion and the distal light scattering means 60 at the head portion 20 is generally unnoticeable or just marginally observable along the length of the hollow tubular optical guide. Consequently, the lighting device 10 appears to include two light separate sources while, remarkably, there is only a single light source disposed in the base portion 40 of the lighting device 10. The hollow tubular member further includes a first and a second radially extending collar members at its distal ends. The upper collar member 72 provides a more comfortable seat for the distal light scattering means while the lower collar member 73 provides a more stable connection to the base portion 40 of the lighting device 10.

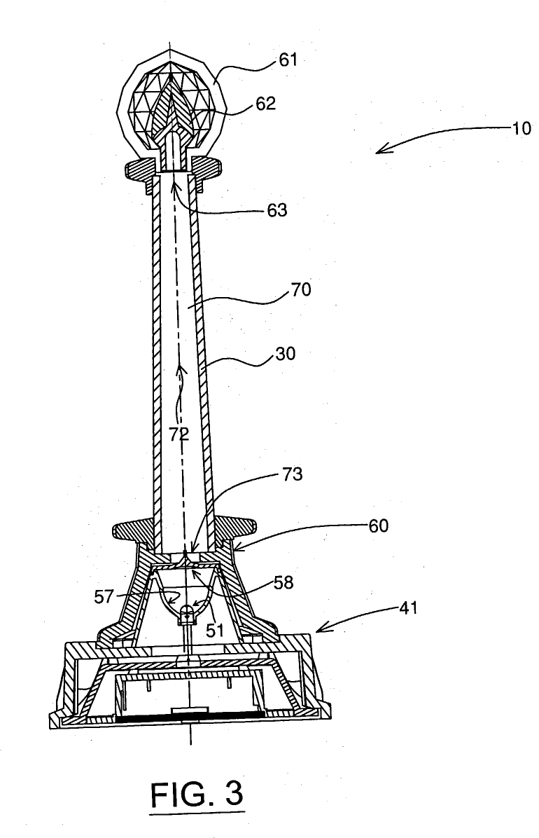

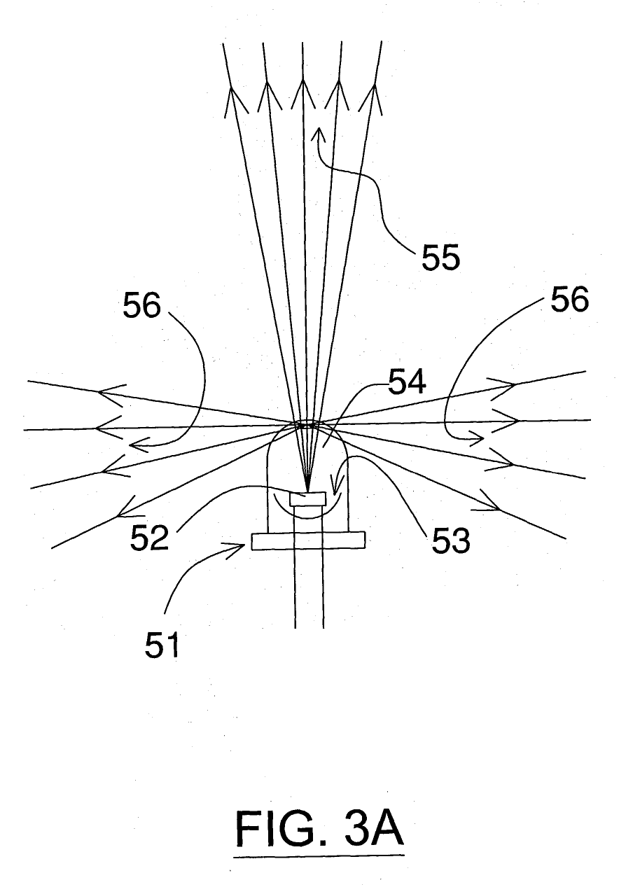

Turning now to the arrangement of the light source 50, the light source 50 includes a light-emitting member 51 which, in this specific example, is a packaged LED. As shown in FIG. 3A, the packaged LED 51 includes a light-emitting element which is the actual light-emitting diode, a light reflector 53 and a light diffusing member 54. The light reflector 53 of a packaged LED is generally designed and adapted to reflect a portion of the light generated by the light-emitting diode along a prescribed direction with certain viewing angles. The viewing angle is a general measure of the spread or divergency of the beam emerging from the light-emitting diode. The light diffusing body 54 includes a substantially clear and transparent body which is generally cylindrical with a rounded head portion, or more specifically, a dome-shaped head portion.

The design and configuration of this light diffusing body 54 allows a portion of the light generated by the light-emitting diode to travel towards the rounded head portion and exit along the prescribed direction 55. In addition, as the light diffusing body 54 is made of a transparent material with a relatively high refractive index, a portion of the generated and reflected light will be deflected or refracted sideways generally along the directions 56 due to the rounded or dome-shaped profile of the head portion of the light diffusing body 54. As a result, light emerges along the prescribed direction 55 as well as sideways along the directions 56. By disposing the light-emitting member 51 at the base portion 40, with the axis of the cylindrical body or the rounded head aligned along the longitudinal axis 72 of the hollow tubular member and towards the distal light scattering means 60, the distal light scattering means will be luminous when the light-emitting member 51 is turned on to emit light.

At the same time, the light-emitting member 51 is surrounded by a housing portion which includes at least a transparent or a translucent window or surface. When the light-emitting member 51 is turned on, light generated by the light-emitting diode 52 and will also be deflected sideways generally along the directions 56 due to the diffusing refraction or scattering characteristics of the light diffusing body 54. As a result, the transparent or translucent surface of the base housing 41 will also be luminous or glowing. Hence, with the above arrangements, a very remarkable and interesting phenomenon that two substantially optically separated luminescent portions can be produced by means of a single light-emitting source. In the present specific example, the light-emitting member 51 is further surrounded by a translucent body 57 to smoothen the light emitted along the directions 56 by diffusion, diffraction or even scattering by the translucent member 57. The translucent member 57 in this example includes a generally parabolic member with its parabolic axis aligned towards the distal light scattering means 60.

Referring to FIG. 3, the light generated by the light-emitting member 51 which travels towards the distal light scattering means 60 will enter the optical guide 70 through the entry aperture 73. It will be noted that the entry aperture 73 is generally larger than the projection of the head portion of the light-emitting member along its cylindrical axis. Furthermore, focusing or collimating means 73 is disposed intermediate of the optical guide 70 and the light-emitting member 51 in order to collimate the light towards the distal scattering means 60. The collimating means 73 in the present example includes a transparent plate with a rounded protrusion elevated above the rest of the plane. The rounded protrusion is shaped so that the diverging light travelling along the direction 55 will be collimated towards the light scattering member 61 to alleviate the portion of light which will escape away from the optical guide. Furthermore, batteries as well as driving circuitry for the LED are disposed within the base portion of the lighting device 10.

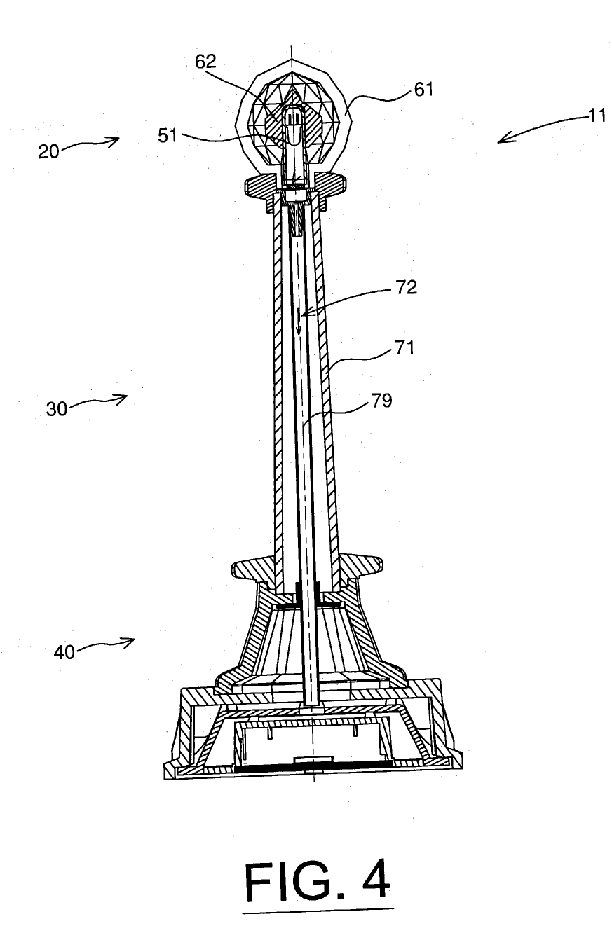

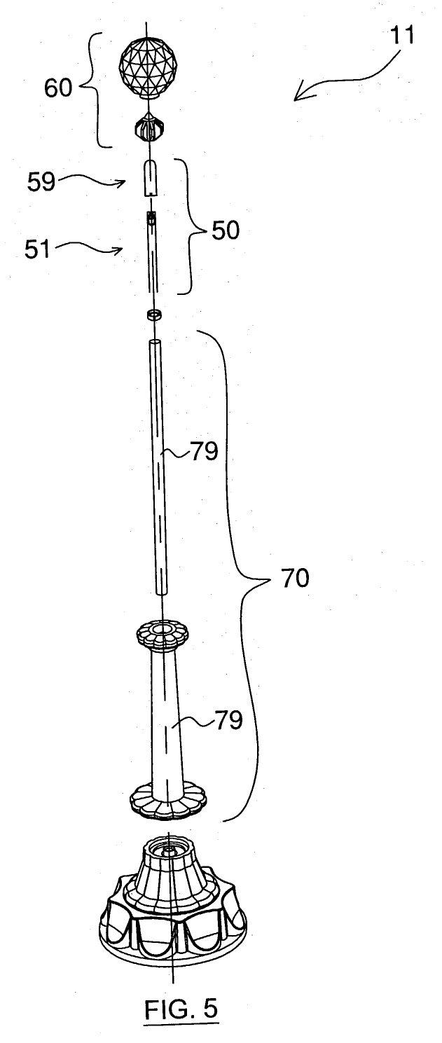

Referring to FIGS. 4 and 5 showing a second preferred embodiment of this invention, the lighting device 11 also includes a head portion 20, a neck portion 30 and a base portion 40 with the base housing 41 which are generally identical to that of the lighting device 10 of the first preferred embodiment and therefore share the same reference numerals. In the specification below, parts or components which are generally identical or equivalent to that of the first preferred embodiment 10 will share the same reference numerals unless the context otherwise requires. In this preferred embodiment, the light-emitting member 51 is disposed inside the intermediate light scattering body 62 with its rounded head aligned towards the base portion 40 of the lighting device 11 and along the longitudinal axis of the optical guide 79.

The optical guide 79 is enclosed within the transparent hollow tubular member 71 and extends generally along the entire length of the hollow tubular member. When the light-emitting member 51 is turned on, light generated by the LED will travel from the head portion 20 towards the base portion 40 along the elongated optical guide 79. The elongated optical guide 79 is substantially solid and cylindrical and is made of a light scattering material so that light travelling along the optical guide 79 will be scattered radially or sideways, thereby forming a glowing or luminescent phenomenon along the length of the optical guide 79. In addition, the light diffusing or scattering effect of the optical guide 79 also means that the optical guide is generally light attenuating. As a result, the luminosity or degree of glowing will diminish as the light travel further away from the light source 50 which is disposed inside the head portion 20 of the lighting device 11. With this arrangement, a very remarkable and interesting phenomena that the lighting device includes a luminescent light scattering body 61 as well as a luminescent rod with a distributed lighting effect. In this arrangement, length of gradually diminishing light can be observed along the generally luminescent rod. To ensure that a substantial portion of the light generated by the light source 50 will be transmitted to the optical light guide 79, a generally transparent reflector with a rounded or parabolic reflective surface is disposed adjacent to the light-emitting diode with the rounded head of the light-emitting diode 52 disposed away from the reflective surface of the reflector 59. An example of a suitable elongated optical guide 79 is a plastic rod doped or dispersed with a light scattering medium, such as a fluorescent powder.

While the present invention has been explained by reference to the preferred embodiments described above, it will be appreciated that the embodiments are only illustrated as examples to assist understanding of the present invention and are not meant to be restrictive on its scope. In particular, the scope, ambit and spirit of this invention are meant to include the general principles of this invention as inferred or exemplified by the embodiments described above. More particularly, variations or modifications which are obvious or trivial to persons skilled in the art, as well as improvements made on the basis of the present invention, should be considered as falling within the scope and boundary of the present invention.

Furthermore, while the present invention has been explained by reference to candle-light light devices, it should be appreciated that the invention can apply, whether with or without modifications, to other luminous means, devices and apparatus without loss of generality.

1. Alighting device (10, 11) including:
(a) a light source,
(b) a distal light scattering means,
(c) a transparent or translucent surface,
(d) said distal light scattering means being disposal at a distance away from said light source and outside said housing (60),
(e) said distal light scattering means becomes generally luminous when illuminated by said light source, and
(f) said light source being surrounded by a housing (60) including at least a transparent or translucent surface.

2. A light device of claim 1, wherein said light source includes a light-emitting body which includes a light-emitting element, a light reflector and a light diffusing member, said light-emitting element being disposed intermediate of said light reflector and said light diffusing element, said light reflector being disposed to reflect light emitted by said light emitting element towards said light diffusing member and said distal light scattering means.

3. A lighting device of claim 2, wherein said light diffusing member includes a clear transparent body with a generally dome-shaped head, the top of said dome-shaped head being generally aligned towards said distal light scattering means.

4. A lighting device of claim 2, wherein said light source includes a packaged light-emitting diode (LED) including said light-emitting element, said light reflector and said light diffusing member packaged together.

5. A lighting device of claim 1, wherein a light scattering optical guide is disposed between said light source and said distal light scattering means, said distal light scattering means being luminous when said light source emits light during normal use.

6. A lighting device of claim 1, wherein an optical guide (70) is disposed between said light source and said distal light scattering means so that light emerging from said light source can be guided along said optical guide towards said distal light scattering means.

7. A lighting device of claim 6, wherein said optical guide includes an elongated hollow tubular member generally extending between said light source and said distal light scattering means.

8. A lighting device of claim 7, wherein the cross-sectional area of the aperture (71) of said hollow tubular member juxtaposing said light source is substantially larger than the light-emitting surface of said light source projected along the direction extending between said light source and said distal light scattering means.

9. A lighting device of claim 8, wherein an optical collimating means (72, 73) is disposed to collimate light generated by said light source towards said aperture of said hollow tubular member juxtaposing said light source.

10. A light device of claim 6, wherein said optical guide being luminous when said light source emits light during normal use.

11. A lighting device of claim 1, wherein said distal light scattering means include a hollow light scattering body with a light admitting aperture, said light admitting aperture being aligned.

12. A lighting device of claim 11, wherein said hollow light scattering member includes a hollow body made of a highly refractive transparent or translucent material.

13. A lighting device of claim 12, wherein the outer surface of said hollow body being generally faceted.

14. A lighting device according to claim 1, wherein a transparent focusing means (72) is disposed between said light source and said distal light scattering means.

15. A lighting device according to claim 1, wherein a reflective focusing means (73) is disposed to focus light from said light source to said distal light scattering means.

16. A lighting device according to claim 15, wherein said reflective focusing means being semi-reflective.

17. A lighting device according to claim 5, wherein the luminosity of said light scattering optical guide gradually diminishes as said light scattering optical guide extends away from said light source and becomes non-luminescent at a distance before the distal end of said light scattering optical guide, wherein said scattering means (30) being disposed juxtaposing said distal end of said light scattering optical guide being luminous.

18. A lighting device of claim 1, wherein said light source includes at least a light-emitting diode.

19. Alighting device (10, 11) including:
a. a light source (20),
b. a first distal light scattering means,
c. a second distal light scattering means, and
d. an optical connection means interconnecting said light source, said first distal light scattering means and said second distal light scattering means, wherein said first and said second distal light scattering means being luminous when said light source is generating light.
